(19) United States
(12) Patent Application Publication
(10) Pub. No.: US 2002/0027423 A1
(43) Pub. Date: Mar. 7, 2002

(54) Method and circuit for driving a brushless dc motor to reduce low acoustic noise

(75) Inventor: Bertram J. White, Irvine, CA (US)

Correspondence Address: TEXAS INSTRUMENTS INCORPORATED, P O BOX 655474, M/S 3999, DALLAS, TX, 75265

(73) Assignee: Texas Instruments, Inc.

(21) Appl. No.: 09/957,369

(22) Filed: Sep. 20, 2001

Related U.S. Application Data
(63) Continuation-in-part of application No. 09/625,292, filed on Jul. 25, 2000, now Pat. No. 6,323,610.
Application No. 09/625,292 is a continuation-in-part of application No. 09/300,754, filed on Apr. 26, 1999, now Pat. No. 6,236,174.
Application No. 09/625,292 is a continuation-in-part of application No. 09/448,571, filed on Nov. 23, 1999, now Pat. No. 6,252,362.

(51) Int. Cl. H02P 1/18; H02P 3/08; H02P 5/06; H02P 7/06; H02K 23/00

(52) U.S. Cl. 318/254

(57) ABSTRACT

A method and circuit (16) for driving a polyphase dc motor (14) of the type used in a mass data storage device (10) includes a commutator (55) for commutating drive voltages among windings (44-46) of the dc motor (14). In each commutation cycle, drive voltages are applied to two windings and a current summed from currents induced by the drive voltages is sunk from a third winding. A circuit (76) is provided for pulse width modulating the drive voltages during successive phase commutation cycles in respective pulse width modulated (PWM) cycles, and a circuit (66) is provided for measuring an amount of energy delivered to the motor from a beginning of each PWM cycle. A circuit (78-80, 70-72) terminates the drive voltages in a PWM cycle when the circuit (66) for measuring measures a predetermined amount of energy that has been delivered to the motor during the PWM cycle.

### REFERENCES TO APPLICATIONS FROM WHICH PRIORITY IS CLAIMED

This application is a continuation-in-part of co-pending application Ser. No. 09/625,292, filed Jul. 25, 2000, which is a continuation-in-part of application Ser. No. 09/300,754, filed Apr. 26, 1999, now U.S. Pat. No. 6,236,174, and is a continuation-in-part of co-pending application Ser. No. 09/448,571, filed Nov. 23, 1999, all of said applications being incorporated herein by reference.

### BACKGROUND OF INVENTION

1. FIELD OF INVENTION

This invention relates to improvements in methods and circuits for driving dc, brushless, polyphase motors, such as a spindle motor of a mass data storage device, or the like, and more particularly to improvements in such driving methods and circuits that at least reduce the acoustic noise in motors of this type, and to improvements in driving methods and circuits for driving such motors without regard to whether or not the motor has a sinusoidal bemf.

2. RELEVANT BACKGROUND

This invention relates primarily to improvements in circuitry for use in controlling the spindle motor of mass data storage devices. Mass data storage devices include tape drives, as well as hard disk drives that have one or more spinning magnetic disks or platters onto which data is recorded for storage and subsequent retrieval. Hard disk drives may be used in many applications, including personal computers, set top boxes, video and television applications, audio applications, or some mix thereof. Many applications are still being developed. Mass data storage devices may also include optical disks in which the optical properties of a spinning disk are locally varied to provide a reflectivity gradient that can be detected by a laser transducer head, or the like. Optical disks may be used, for example, to contain data, music, or other information.

Typically, mass data storage devices use polyphase, usually three-phase, dc motors to rotate the memory media. In the operation of such dc, brushless, polyphase motors of the type to which the invention pertains, efficient motor drive requires that the excitation current applied to the motor phases be aligned with the back electromotive force (bemf) generated by individual phases. One of the best schemes for achieving this alignment is the use of a phase-locked loop (PLL), which adjusts the phase and frequency of the commutation, so that the bemf of each winding passes through zero in the center of the appropriate commutation state. If there is a significant phase error, torque ripple occurs which results in an unevenness or jerkiness in the motor rotation, and which may excite resonances in the motor causing undesirable acoustic noise.

To address this problem in the past, care has been taken to assure that a pure sine wave shaped excitation signal is applied to the motor. To provide for such sinusoidal waveforms, use of various segmented and concatenated waveforms has been proposed. This scheme works well when the shape of the commutation waveforms includes an undriven region, as in a conventional 6 -state, +1, +1, 0, −1, −1, 0, sequence.

Since the +1, +1, 0, −1, −1, 0 sequence has sharp transitions between driving states, this sequence has many high frequency components. These tend to excite mechanical resonances in the motor, which results in the creation of undesirable acoustic noise. Moreover, the step-function tristating of the undriven motor phases, together with the step-function driving waveform itself produces a degree of torque ripple in the motor. The torque ripple results in an unevenness or jerkiness in the motor rotation, which also excites resonances in the motor, also causing undesirable acoustic noise. Thus, if it is desired to reduce acoustic noise, a sine wave shaped excitation signal is more appropriate than the 6-state sequence.

It is also desirable to use a PWM (Pulse Width Modulation) scheme in order to maximize power efficiency. PWM permits lower cost packaging and an overall saving in system cost. However, in the past, it has been difficult to generate currents that have a pure sinusoidal waveform, particularly when the currents are relatively high, and when a PWM scheme is desired to be used.

In previous application Ser. No. 09/300,754, filed 4/26/99, which is incorporated herein by reference, after initial baseline cancellation, a driving waveform was formed of concatenated segments of 120° of zero, followed by 120° of “up hook”, and 120° of “down hook”. The up-hook and down-hook waveforms were generated in two MDACs. The operation of the MDACs had some problems that resulted in difficulty in forming the desired driving waveforms. In particular, circuit tradeoffs needed to be made so that the resulting waveforms could properly operate in the polyphase dc motor environment.

Also, using an MDAC to form waveform segments that are themselves formed from sinusoidal waveforms segment combinations requires special MDAC design and operational considerations. A design in which the driving waveforms can be constructed from linear waveform segments to approximate the sinusoidal waveforms segment combination would significantly ease the realization and operation of such MDAC.

To complicate the situation, a demand has recently arisen for the use of non-sinusoidal motors. When non-sinusoidal motors are driven with sinusoidal waveform segments, torque ripple occurs at harmonics of the commutation rate. Although the result is substantially better than 6-state drivers, it can be improved further. One way that this problem may be addressed is by downloading parameters describing the motor bemf and using this data to modify the drive signals.

Devices that generate sinusoidal voltage have proven to be robust and fairly compact. Although a PWM modulator converts these voltages to the actual waveforms applied to the motor, it is most convenient to regard the sine waves themselves as driving the motor. The amplitude of these sine waves is adjusted by an internal feedback loop (the transconductance loop) to force the average current in the sense resistor of the drivers to agree with a current command from the external DSP. The final amplitude of the sine waves must be slightly larger than the motor bemf. The actual peak-to-peak value is V_{bemf(pp)}+2IR, where I is the desired peak current and R is the winding resistance of the motor.

As an example, when running, a typical motor might have a bemf peak-to-peak voltage of 8v and a per-phase resistance of 2 ohms. In single platter disk drives, the run current may be as low as 100 mA. In this situation, the peak-to-peak sine wave voltage must be 8 V+0.4 V=8.4 V. If the amplitude of the sine wave drops 5%, to 8 V, the current will drop 100%. Thus, even a small distortion in the amplitude or shape of the sine wave can cause large disturbances in the motor current. The two significant sources of distortion are non-sinusoidal bemf and slew rate limiting in the PWM output drivers.

Consequently, what is needed is a disk drive and method for operating it in which the noise associated with the drive in operation is reduced or eliminated. What is additionally needed is a disk drive and method that employs drive signals that need not be sinusoidal, and are not necessarily reliant upon prior knowledge about the bemf shape of the drive motor.

### SUMMARY OF INVENTION

In light of the above, therefore, it is an object of the invention to provide an improved disk drive and method for operating it in which the noise associated with the drive in operation is reduced or eliminated.

It is still another object of the invention to provide a disk drive and method that employs multiple drive signals that are additively applied during PWM cycles such that the same amount of energy is transferred from the power supply to the motor on each PWM cycle.

It is yet another object of the invention to provide a disk drive and method that can be employed without regard to whether or not the motor has a sinusoidal bemf.

These and other objects, features, and advantages will become apparent to those skilled in the art, when the following detailed description is read in conjunction with the accompanying drawings and appended claims.

The present invention solves the problem of driving a brushless dc motor with high efficiency and low acoustic noise without assuming the motor has sinusoidal bemf. Thus, according to a broad aspect of the invention, a method is presented for driving a polyphase dc motor. The method includes pulse width modulated drive voltages to the motor during successive phase commutation cycles in respective pulse width modulated (PWM) cycles, and transferring an equal amount of energy from a power supply to the motor in each PWM cycle. The transfer includes measuring a quantity of energy transferred to the motor from a start of a PWM cycle, and terminating the transfer when the quantity reaches a predetermined value. The measuring includes accumulating a quantity in a one or more integrators proportional to charge delivered to the motor during each PWM cycle, and providing an integrator output state that indicates when the integrator has reached a predetermined value.

According to another broad aspect of the invention, a method is presented for driving a polyphase dc motor. The method includes commutating drive voltages among respective windings of the motor and pulse width modulating the drive voltages during each of the six commutation states. The pulse width modulating during a first commutation state includes applying wide pulses of controlled width to a first winding, applying narrower pulses of successively increasing width to a second winding, and conducting currents produced in the first and second windings through a third winding and a sense resistor connected thereto. The pulse width modulating during a subsequent second commutation state includes applying the wide controlled width pulses to the second winding, applying narrower pulses of successively decreasing width to the first winding, and conducting currents produced in the first and second windings through the third winding and the sense resistor. The method also includes measuring an amount of energy delivered to the sense resistor during each pulse width modulating cycle, and terminating the pulses during a pulse width modulating cycle if a predetermined fixed amount of energy is measured.

In one embodiment, the pulses of successively increasing width and the pulses of decreasing width are each centered about a center of a respective one of the pulses of controlled width.

According to yet another broad aspect of the invention, a circuit is presented for driving a polyphase dc motor. The circuit includes means for commutating drive voltages among respective windings of the motor and means for pulse width modulating the drive voltages applied to each winding. The means for pulse width modulating the drive voltages includes means for applying pulses of controlled width to a first winding during a first commutation state, means for applying narrower pulses of successively increasing width to a second winding during the first commutation state, and means for conducting currents produced in the first and second windings through a third winding and a sense resistor connected thereto during the first commutation state. The means for pulse width modulating the drive voltages includes means for applying pulses of the controlled width to the second winding during a subsequent second commutation state, means for applying pulses of successively decreasing width to the first winding during the subsequent second commutation state, and means for conducting currents produced in the first and second windings through the third winding and the sense resistor during the subsequent second commutation state. The circuit also includes means for measuring an amount of energy delivered to the sense resistor during each pulse width modulating cycle, and means for terminating the pulses during a pulse width modulating cycle if a predetermined fixed amount of energy is measured.

According to still another broad aspect of the invention, a circuit is presented for driving a dc motor. The circuit includes a commutator for commutating drive voltages among windings of the dc motor. In each commutation cycle, drive voltages are applied to two windings and a current summed from currents induced by the drive voltages is sunk from a third winding. A circuit is provided for pulse width modulating the drive voltages during successive phase commutation cycles in respective pulse width modulated (PWM) cycles, and a circuit is provided for measuring an amount of energy delivered to the motor from a beginning of each PWM cycle. A circuit terminates the drive voltages in a PWM cycle when the circuit for measuring measures a predetermined amount of energy that has been delivered to the motor during the PWM cycle.

According to still yet another broad aspect of the invention, a mass data storage device is presented. The mass data storage device includes a magnetic media and a dc motor for rotating the magnetic media. The motor has a plurality of windings to receive commutated drive voltages for spinning the motor. A commutator commutates drive voltages among the windings so that in each commutation cycle, drive voltages are applied to two windings and a current summed from currents induced by the drive voltages is sunk from a third winding. A circuit pulse width modulates the drive voltages during successive phase commutation cycles in respective pulse width modulated (PWM) cycles, and a circuit measures an amount of energy delivered to the motor from a beginning of each PWM cycle. A circuit terminates the drive voltages in a PWM cycle when the circuit for measuring the amount of energy delivered to the motor from a beginning of each PWM cycle measures a predetermined amount of energy that has been delivered to the motor during the PWM cycle.

In still yet another broad aspect of the invention, a method is presented for operating a mass data storage device. The method includes commutating drive voltages among windings of a dc motor of the mass data storage device for rotating a memory element thereof. In each commutation cycle, drive voltages are applied to two windings and a current summed from currents induced by the drive voltages is sunk from a third winding. The drive voltages are pulse width modulated during successive phase commutation cycles in respective pulse width modulated (PWM) cycles, and an amount of energy delivered to the motor from a beginning of each PWM cycle is measured. The drive voltages in a PWM cycle are terminated when the circuit for measuring measures a predetermined amount of energy that has been delivered to the motor during the PWM cycle.

In still another broad aspect of the invention, a method is presented for pulse width modulating three drive voltages for application to a three-phase load. The method includes commutating the drive voltages among the phases of the load. In each pulse width modulation cycle, two of the drive voltages are is applied to a respective two phases of the load, and a current summed from currents induced by the two of the drive voltages is sunk from a third phase of the load. An amount of energy delivered to the load from a beginning of each PWM cycle is measured, and the drive voltages in a PWM cycle are terminated when a predetermined amount of energy that has been delivered to the motor during the PWM cycle has been measured.

### BRIEF DESCRIPTION OF DRAWINGS

The invention is illustrated in the accompanying drawings, in which:

FIG. 1 is a block diagram of a generic disk drive system, illustrating a general environment in which the invention may be practiced.

FIG. 2 is a block diagram, showing a first circuit embodiment for achieving a constant energy transfer to the motor in each PWM cycle, according to a preferred embodiment of the invention.

FIG. 2A is a block diagram, showing a second circuit embodiment for achieving a constant energy transfer to the motor in each PWM cycle, according to a preferred embodiment of the invention.

FIG. 3A-3F are simulated waveforms showing the “slope” and “cap” voltage drive segments applied to the windings of a three phase motor for each of the six commutation states listed in Table 1 below, in accordance with a preferred embodiment of the invention.

FIGS. 4A and 4B show the simulated values supplied by the control circuitry for the VSLOPEMAX, VSLOPEMIN, VCAPMAX AND ISNSINT signals at various commutation times, in conjunction with the commutation signals of FIGS. 3A-3F, in accordance with a preferred embodiment of the invention.

FIGS. 5A-5C show a series of simulated waveforms of the coil driving currents (ia, ib, and ic), bemf voltage (nbemfa), torque (torque_z) and torque contributed by each phase (atorque_z), in accordance with a preferred embodiment of the invention.

FIGS. 6A-6C show a series of simulated waveforms of the coil driving currents (ia, ib, and ic), bemf voltage (nbemfa), torque (torque_z) and torque contributed by each phase (atorque_z), in a case where a 20v/μs slew rate is applied, in accordance with a preferred embodiment of the invention.

FIGS. 7A-7C show a series of simulated waveforms of the coil driving currents (ia, ib, and ic), bemf voltage (nbemfa), torque (torque_z) and torque contributed by each phase (atorque_z), in a case where a 20v/μs slew rate is applied and a 3% bemf distortion is applied, in accordance with a preferred embodiment of the invention.

In the various figures of the drawing, like reference numerals are used to denote like or similar parts.

### DETAILED DESCRIPTION OF A PREFERRED EMBODIMENT

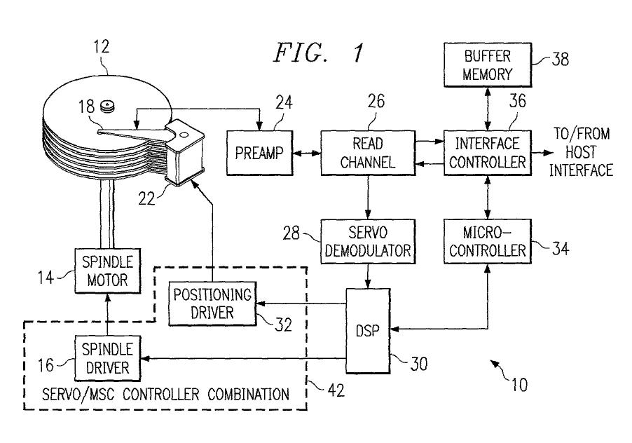

FIG. 1 is a block diagram of a generic disk drive system 10, which represents a general environment in which the invention may be practiced. The system includes a magnetic media disk 12 that is rotated by a spindle motor 14 and spindle driver circuit 16. A data transducer or head 18 is locatable along selectable radial tracks (not shown) of the disk 12 by a voice coil motor 22. The radial tracks may contain magnetic states that contain information about the tracks, such as track identification data, location information, synchronization data, as well as user data, and so forth. The head 18 is used both to record user data to and read user data back from the disk, as well as to detect signals that identify the tracks and sectors at which data is written, and to detect servo bursts that enable the head to be properly laterally aligned with the tracks of the disk, as below described.

Analog electrical signals that are generated by the head 18 in response to the magnetic signals recorded on the disk are preamplified by a preamplifier 24 for delivery to read channel circuitry 26. Servo signals are detected and demodulated by one or more servo demodulator circuits 28 and processed by a digital signal processor (DSP) 30 to control the position of the head 18 via the positioning driver circuit 32. The servo data that is read and processed may be analog data that is interpreted by the DSP 30 for positioning the head 18.

A microcontroller 34 is typically provided to control the DSP 30, as well as an interface controller 36 to enable data to be passed to and from a host interface (not shown) in known manner. A data memory 38 may be provided, if desired, to buffer data being written to and read from the disk 12.

As mentioned above, it is desirable to use a PWM (Pulse Width Modulation) scheme in order to maximize power efficiency, and achieve lower packaging and system costs. Thus, in accordance with a preferred embodiment of the invention, a PWM scheme is employed in which the same amount of energy is transferred from the power supply to the motor on each PWM cycle. Since the voltage drop across the DMOS driver FETs is small and the voltage drop across the motor resistance is small, essentially all electrical energy delivered to the motor is therefore converted to mechanical energy. Thus, in the disk drive application, constant input energy translates to constant torque. Integrating the sense resistor voltage, and using the integrated voltage to control the total energy that is transferred to the motor on each PWM cycle is used to accomplish this.

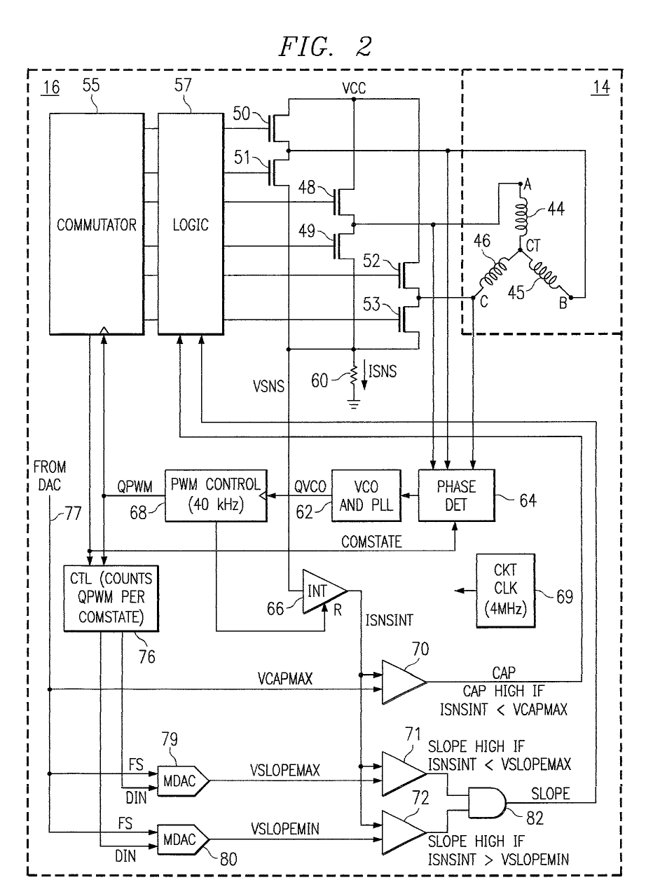

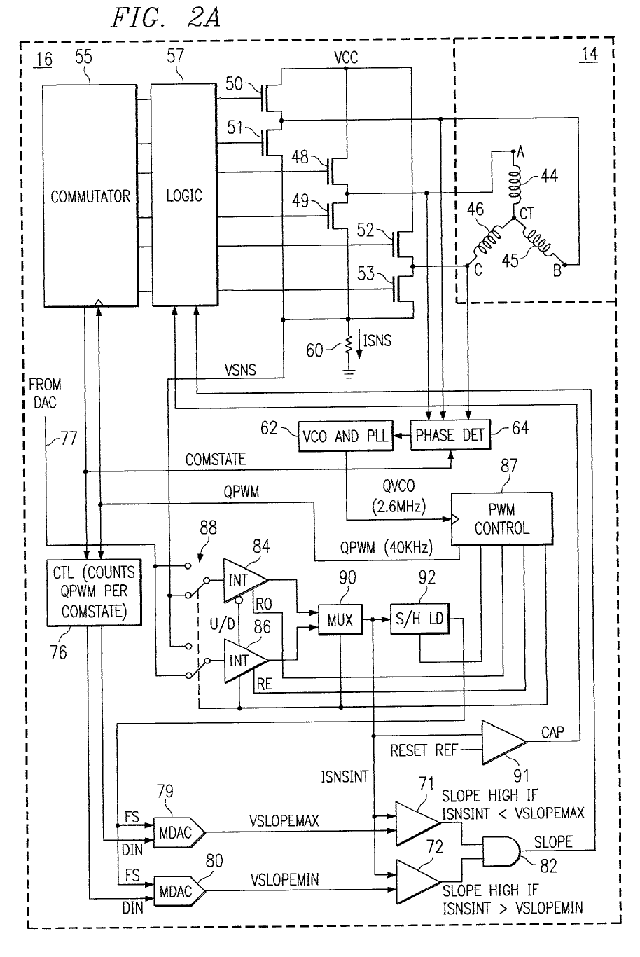

One circuit embodiment for achieving a constant energy transfer in each PWM cycle is shown in FIG. 2, to which reference is now additionally made. The components shown in FIG. 2 include a portion of the spindle motor 14 and a portion of the spindle driver circuitry 16. In the embodiment shown, the motor is a three-phase brushless dc motor, although the invention can be practiced with other motor types. The three-phase motor includes three motor windings 44-46, connected between respective nodes A, B, C, and a common center tap connection (CT). DMOS transistor pairs 48-49, 50-51, and 52-53 commutatively apply drive voltages, respectively to the nodes A, B, and C, under control of a commutator 55 and commutator logic circuitry 57. A sense resistor 60 is connected between the pull-down transistors 49, 51, and 53 to ground to sense the current flowing through the selected motor windings 44-46. A sense voltage, VSNS, is developed across the sense resistor 60 which is proportional to the currents flowing in the respective coils 44-46.

The commutator 55 is driven by clock signals derived from a pulse-width modulation (PWM) control circuit 68, which is controlled by a clock circuit that includes a VCO and PLL circuit 62 and a phase detector 64. The phase detector compares information identifying the commutation state of the commutator 55 (COMSTATE) with the driving signals applied to nodes A-C described above. The output from the phase detector 64, which is fed back to the VCO and PLL to control its frequency, may be, for example, at a commutation frequency of about 4 kHz.

To determine the amount of energy that is being delivered to the motor 14 during each PWM cycle, an integrator 66 is provided. The input to the integrator is connected to receive the sense voltage, VSNS, developed at the top side of the sense resistor 60, so that the voltage developed across the sense resistor 60 in response to the motor currents can be integrated from a beginning time of each PWM cycle.

The PWM control circuit 68 times the PWM cycles at a desired multiple frequency of the commutation cycle frequency developed by the VCO and PLL 62. For example, one suitable PWM frequency multiple may be 10 times the commutation frequency, which is about 40 kHz in the embodiment shown. The PWM control circuit 68 also resets the integrator 66 at the beginning of each PWM cycle.

As will become apparent, the commutation voltages applied to the coils 44-46 are applied in two parts consecutively to two active drive phases. The first part is referred to as the “cap” signal, and the second part is referred to as the “slope” signal. The “cap” signal is commutatively applied to a selected first winding of the motor, the “slope” signal is commutatively applied to a selected second winding of the motor, and the third winding of the motor is connected to ground through the sense resistor 60, in a manner below described in detail.

During each commutation cycle, the maximum, VSLOPEMAX, and minimum, VSLOPEMIN, values of the “slope” signal and the maximum value, VCAPMAX, of the “cap” signal are developed using signals from a control circuit 76 and a value set from the spindle motor DAC (not shown) on line 77. The control circuit 76 receives both the COMSTATE and QPWM signals respectively from the commutation circuit 55 and the PWM control circuit 68, and counts the number of QPWM pulses for each commutation state. The count data is provided to the digital data-in, “DIN”, inputs of a pair of multiplying digital-to-analog converters (MDACs) 79 and 80. The spindle motor DAC signal is applied to the scaling “FS” inputs of the MDACs 79 and 80 to generate the VSLOPEMAX and VSLOPEMIN signals on their respective outputs. The spindle motor DAC determines the maximum “cap” signal, VCAPMAX.

The VCAPMAX, VSLOPEMAX, and VSLOPEMIN signals are connected to respective inputs of comparators 70-72 for comparison to the output, ISNSINT, from the integrator 66, described above. The output from the comparator 70, which represents the “cap” signal, is connected to the commutation control logic 57. Similarly, the VSLOPEMAX AND VSLOPEMIN signals are also compared to the output, ISNSINT, from the integrator 66 in comparators 71 and 72 to provide signals to an AND gate 82. The output from the AND gate 82 is the “slope” signal, which is high so long as the output from the integrator 66 is between the maximum, VSLOPEMYX, and minimum, VSLOPEMIN, signals. The “slope” signal also is connected to the commutation control logic 57.

Thus, in operation since the “VCAPMAX”, “VSLOPEMAX” and “VSLOPEMIN” signals are continuously compared to the output ISNSINT of the integrator 66 in comparators 70-72, when the predetermined allowed energy is determined to have been delivered to the motor during any PWM cycle, the “cap” and “slope” signals are terminated. As will become apparent, the width of the “slope” signals is modulated during each PWM cycle, preferably linearly increasing or decreasing across the PWM cycle.

The commutator 55 is arranged to supply the commutation sequence shown in Table 1 below for the circuit shown in FIG. 2, as follow:

TABLE 1

| State | A | B | C |
|---|---|---|---|
| 1 | CAP | GND | UP |
| 2 | DWN | GND | CAP |
| 3 | GND | UP | CAP |
| 4 | GND | CAP | DWN |
| 5 | UP | CAP | GND |
| 6 | CAP | DWN | GND |

In Table 1, CAP represents a sequence of pulses during a single PWN cycle that have the same duty cycle. UP represents a “slope” curve in which the series of pulses increases in duty cycle, preferably linearly, from zero to the width of a “cap” cycle pulse. DWN represents a “slope” curve in which the series of pulses decreases in duty cycle, preferably linearly, from the width of a “csp” cycle pulse to zero.

It should be noted that in contrast to the normal mode of operating a six state three phase commutation sequence in which only one coil is pulled up and one is pulled down, according to a preferred embodiment of the invention, at any given time, PWM drive signals are applied to transistor pairs in two winding legs, concurrently with drive signals being applied to one active low, or pull-down, transistor in the third winding leg. As a result, the two currents flowing in the PWM pairs will be added in the winding that is pulled down, to flow through the sense resistor 60, as described above.

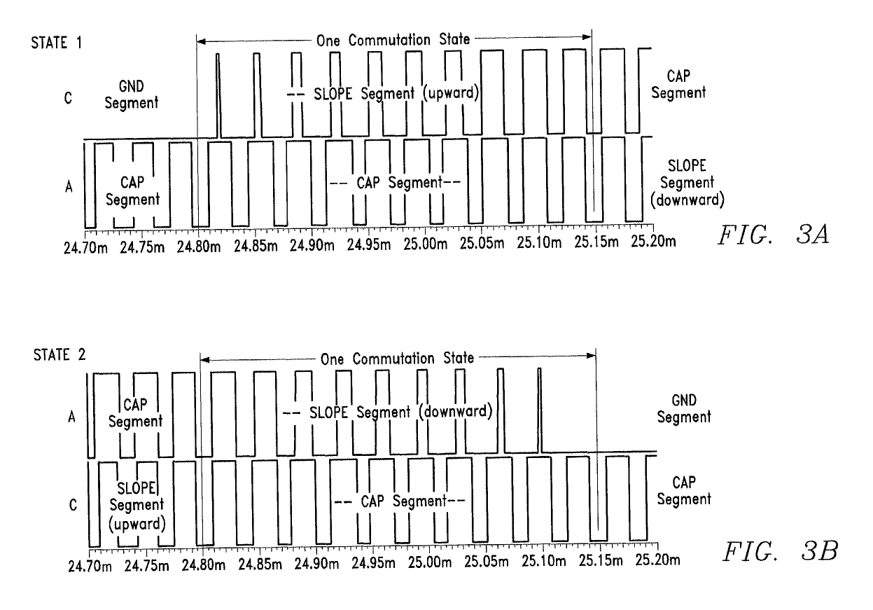

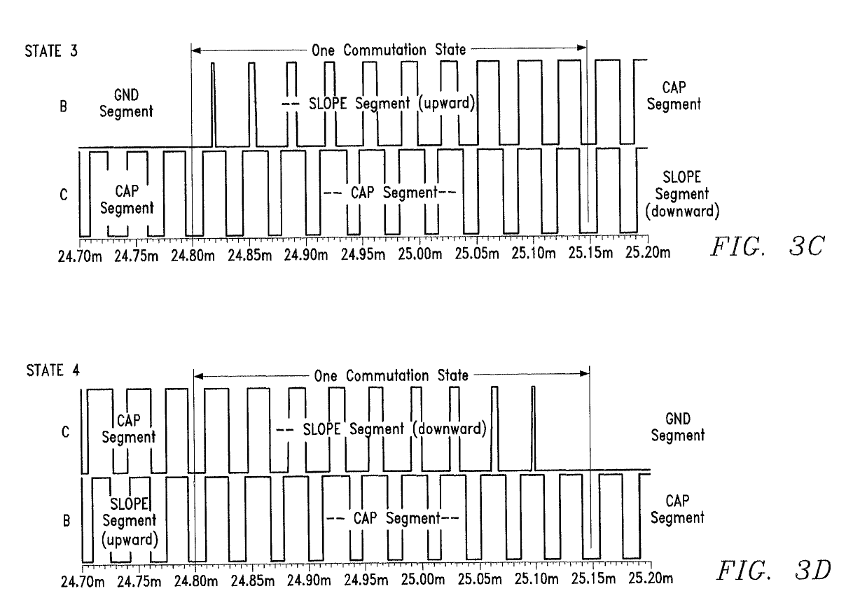

In operation, with additional reference to the waveforms illustrated in FIGS. 3-7, to which reference is now additionally made, in one embodiment, with respect to a normal six state driver, at the beginning of the PWM cycle, the integrator 66 is cleared and one of the appropriate FETs 48, 50, or 52 is enabled to pull its corresponding winding high, and another one of the appropriate FETs 49, 51, or 53 is enabled to pull its corresponding winding low. The selection of the FETs may be, for example, by a traditional six state commutation sequence. The FET that has been enabled to be pulled high is turned on at the beginning of a PWM cycle, and is turned off when the output of the integrator 66 exceeds a threshold set by the spindle motor DAC. Since the PWM frequency is constant and the power supply voltage is constant, constant charge per PWM cycle will cause constant torque.

Significant acoustic benefits can be achieved, according to another embodiment of the invention, if two FETs are selected to be energized at the same time, as described above. One of the two FETs applies a voltage to its corresponding winding with a wide duty cycle, generating a “cap” voltage. The “cap” FET is turned on when the PWM cycle starts and is turned off when the integrator output reaches the spindle motor DAC value as determined in comparator 70. The other FET that is selected to be energized applies a voltage to its corresponding winding that has a duty cycle that is less than or equal to the duty cycle of the “cap” voltage, generating the “slope” voltage. The “slope” FET has a duty cycle of zero at the beginning of the commutation state and a duty cycle equal to the duty cycle of the “cap” FET at the end of the commutation state. The “slope” duty cycle is generated by simple linear interpolation over the course of the commutation state.

FIG. 3A-3F are simulated waveforms showing the slope and “cap” voltage drive segments applied to the windings of a three phase motor for each of the six commutation states listed in Table 1 above, in accordance with a preferred embodiment of the invention. For example, FIG. 3F shows the driving voltages applied to winding nodes A and B, the inputs to the spindle motor output drivers that cause the PH outputs to go high and low. In state 6, illustrated in FIG. 3F, winding B has “down slope” segments applied to it, and winding A has “cap” segments applied to it. In contrast, for example, in state 5, illustrated in FIG. 3E, winding A has “up slope” segments applied to it, and winding B has “cap” segements applied to it.

Thus, it can be seen from Table 1 and FIGS. 3A-3F, every commutation state has either a downslope phase together with a “cap” segment or an upslope phase together with a “cap” segment applied to a selected pair of motor windings. It should be noted that the sequence of signals calls for each winding to receive a single upward (i.e., wider) “slope” segment, two successive “cap” segments and a single downward (i.e.,narrower) “slope” segment on successive commutation states.

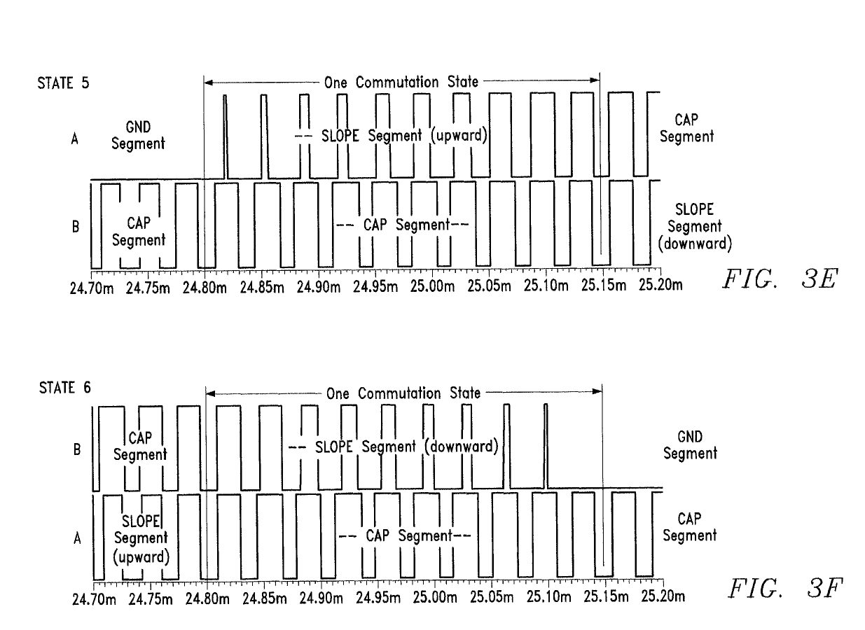

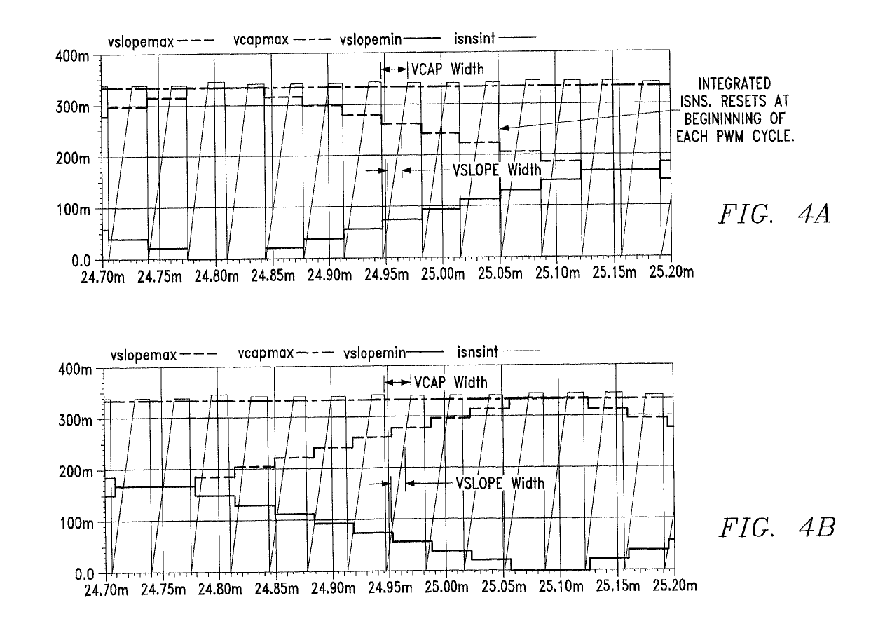

FIGS. 4A and 4B show the simulated values supplied by the control circuitry for the VSLOPEMAX, VSLOPEMIN, VCAPMAX AND INSINT signals at various commutation times, in conjunction with the commutation signals of FIGS. 3A-3F, in accordance with a preferred embodiment of the invention. FIGS. 4A and 4B show the waveforms that generate the “cap” and “slope” segments for respective downslope/cap and upslope/cap waveforms selected by the commutator 55. At the beginning of each PWM cycle the integrator 66 is reset to begin integrating the current, ISNS, through the spindle motor sense resistor 60, and produces an integrated current ISNSINT, at its output. The comparators 70-72 compare ISNSINT to VCAPMAX, VSLOPEMAX, and VSLOPEMIN, respectively. While ISNSINT is below VCAPMAX, the “cap” segment is high. While ISNSINT is between VSLOPEMIN and VSLOPEMAX, the “slope” segment is high. Shortly after the “cap” segment falls, ISNS goes to zero because all FETS are off. The integrator 66 holds the last value of ISNSINT from this point until the next PWM cycle begins.

Since the ISNSINT comparators 70-72 automatically generate duty cycles with the appropriate shape for each bemf of the motor 14, the circuit shown is simpler than previous circuitry. More particularly, the circuit shown does not require a sine wave generator or a transconductance loop. It eliminates the analog input PWM modulators. This, in turn, reduces the requirements for the VCO. No clean analog triangle waveform is required. Only a clock edge at the PWM frequency and a short reset pulse for the integrator are needed.

Thus, one of the goals of the present invention is to generate a “slope” duty cycle that starts at 0 and goes up to equal the duty cycle of “cap” and comes back to 0. Providing a first trigger or threshold at which the “cap” signal is initiated, then providing a moving second trigger or threshold to initiate the “slope” signal, does this. When the second trigger is near zero, a short “slope” pulse is generated. When the second trigger is near the trigger for the “cap” pulse, a “slope” pulse that is the same width as the “cap” pulse is generated. In essence, the width of the “slope” pulses are modulated, and the “cap” pulses adjust for whatever motor drive energy that is left over. So, as the “slope” pulses are turned on and width modulated, the “cap” pulses are turned on and stay on until the total amount of charge delivered to the motor 14 is reached.

Moreover, each “slope” pulse is centered about a corresponding “cap” pulse. When the integrator 66 gets to the slope threshold after the “cap” pulses are turned on, the “slope” pulses are turned on. Then, when integrator gets to the third threshold, the “slope” pulses are turned off. Finally, when the integrator gets to DAC value, the “cap” pulses are turned off.

FIGS. 5A-5C show a series of simulated waveforms of the coil driving currents (ia, ib, and ic), bemf voltage (nbemfa), torque (torque_z) and torque contributed by each phase (atorque_z), in accordance with a preferred embodiment of the invention, showing that there is essentially no distortion and negligible torque ripple when the slew rates are 20 v/μs or faster.

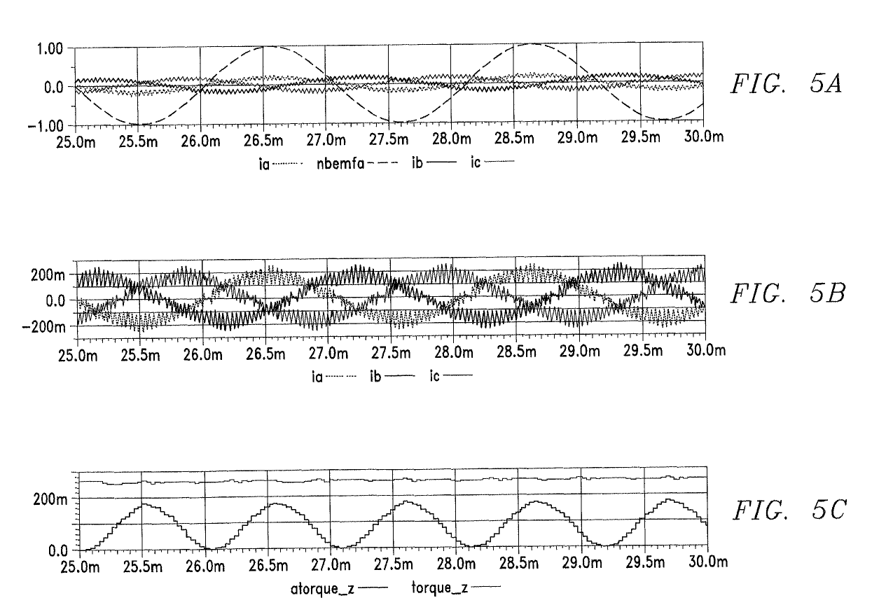

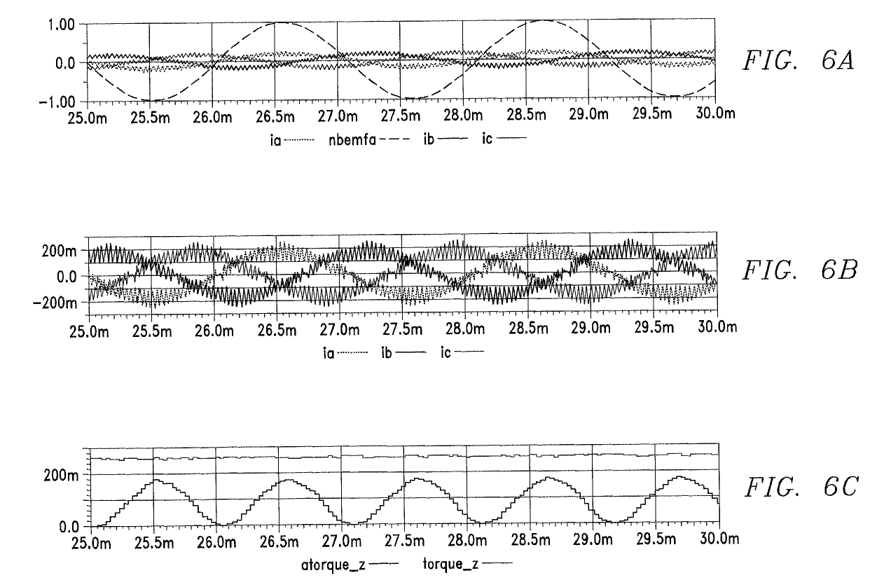

FIGS. 6A-6C show a series of simulated waveforms of the coil driving currents (ia, ib, and ic), bemf voltage (nbemfa), torque (torque-z) and torque contributed by each phase (atorque_z), in a case where a 20 v/μs slew rate is applied, in accordance with a preferred embodiment of the invention. Thus, when distortion is added there is negligible torque ripple and the torque contributed by each phase is still essentially sinusoidal.

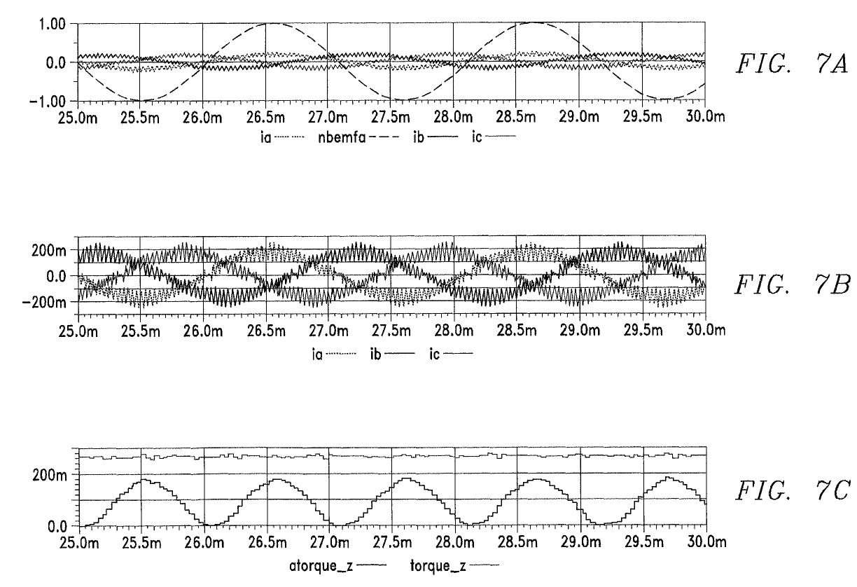

FIGS. 7A-7C show a series of simulated waveforms of the coil driving currents (ia, ib, and ic), bemf voltage (nbemfa), torque (torque_z) and torque contributed by each phase (atorque_z), in a case where a 20 v/μs slew rate is applied and a 3% bemf distortion is applied, in accordance with a preferred embodiment of the invention. A simulation with twice the distortion (6%) was also run and similar results were achieved. Again, the effect on torque ripple is negligible.

As stated earlier, the circuitry of a preferred embodiment of the invention, such as shown in FIG. 2, is simpler than previous circuitry. The sine wave generator that was previously required can be replaced with the considerably simpler circuit 76 that generates the VSLOPEMIN and VSLOPEMAX values. The PWM modulators can be replaced with a single multiplexed comparator, which sequences between VSLOPEMIN, VSLOPEMAX, and VCAPMAX. The VCO 62 does not need to provide the VCODAC, LOWREF, and HIGHREF outputs, which were previously required, but just needs to provide a variable frequency clock for operating the phase detector and a fixed frequency clock for running the PDIM when SYNCHON is off. In fact, a digital circuit should provide the VCO and PLL 62 functions, operating from a source of clock pulses. The overall pin count can be reduced by removing the previously required CVCO, RC, and VMAG pins.

In the design of the ISNS integrator 66, during start, the circuit should have good control over the supply current. Herein, “the supply current” means the average supply current over each PWM cycle. Thus, accurate control over the relationship between the PWM frequency and the integrator time constant needs to be maintained. One method of doing this is to use a switched capacitor integrator (not shown). The circuit preferably clocks at least 100× faster than the PWM rate to provide sufficient time resolution to the PWM duty cycles. For example, if the PWM rate is 40 kHz, the clock rate provided by the circuit clock 69 must be 4 MHz, as shown. This is probably the cheapest implementation. The circuit 16 may be constructed in other ways as well as that shown, For example, alternatively, the circuit 16 may be fully digitally implemented, with a 4 MHz, for example, digitizer converting ISNS. Or the circuit may be implemented in fully analog devices, with the time constant either trimmed, controlled with a replica circuit, or both.

In yet another preferred embodiment of the invention, a “dual slope” integration technique may be used instead of the simple up integrator 66 described with respect to FIG. 2. A dual slope embodiment is shown in FIG. 2A, to which reference is now additionally made. In this embodiment, two up/down integrators 84 and 86 are switched by switches 88 to selectively receive on their inputs either the output from the spindle motor DAC on line 77 or the sense resistor voltage, VSNS. The outputs from the integrators 84 and 86 are multiplexed in a multiplexer 90 to provide the output of the selected integrator as signal ISNSINT to the comparators 71 and 72, as well as to a sample and hold (S/H) circuit 92.

A PWM control circuit 87 controls switches 88 to switch the inputs to the integrators 84 and 86 between the spindle motor DAC and the sense voltage, VSNS, on sense resistor 60, such that when the spindle motor DAC is connected to one integrator, the sense voltage, VSNS, is applied to the other, and vice versa. At the same time, the PWM control circuit 87 switches the multiplexer 90 to direct the active integrator to the sample and hold circuit 92 and the comparators 71 and 72.

The PWM control circuit 87 also alternately resets the integrators 84 and 86 on even and odd cycles, the respective reset lines being denoted as RE and RO. Finally, the PWM control circuit 87 resets the sample and hold circuit at the end of each up count of each PWM cycle, so that the held value represents the maximum value reached by the active integrator. This held value is used to provide the scaling signal “FS” to the inputs of MDACs 79 and 80 to develop the VSLOPEMAX and VSLOPEMIN signals, which are inputted to comparators 71 and 72 to be compared to the selected integrated signal, ISNSINT.

The selected instantaneous integrated signal, ISNSINT, is applied to a comparator 91 to be compared to a reset reference value to provide the “cap” signal on its output line to the logic circuit 57. The VSLOPEMAX and VSLOPEMIN signals are also compared to the instantaneous integrated signal, ISNSINT, in comparators 71 and 72 for comparison to develop the “slope” signal, in the same manner as described above with respect to the circuit of FIG. 2.

In operation, during a first PWM cycle, a first one of the integrators is reset, and integrates the DAC output upward from the reset voltage of the integrator for a predetermined percentage of a PWM cycle (86%, for instance). At the end of the first PWM cycle, the output of the integrator is loaded into the sample and hold circuit 92. Then, on the next PWM cycle, the first integrator negatively integrates the sense voltage, VSNS, and ramps back down to the reset voltage, thereby assuring that the energy measured across the sense resistor 60 is proportional to the energy dictated by the spindle motor DAC. During this phase of operation, the integrator output is selected by the multiplexer 90 to provide the ISNSINT signal to the comparators 71 and 72 and to the sample and hold circuit 92.

After the first integrator has completed half of its cycle, at the start of the second PWM cycle, the second integrator is reset, and integrates the DAC output upward from its reset voltage for the predetermined PWM cycle percentage. At the end of the second PWM cycle, the output of the integrator is loaded into the sample and hold circuit 92, replacing the previously loaded value from the first integrator. Then, on the next following, or third, PWM cycle, the second integrator integrates the sense voltage, VSNS, back down to the reset voltage, again assuring that the energy measured across the sense resistor 60 equals the energy dictated by the spindle motor DAC. During this phase of operation, its output is selected by the multiplexer 90 to provide the ISNSINT signal to the comparators 71 and 72 and to the sample and hold circuit 92. Thus, the integrators overlap in operation, but are selected so that they continuously provide an output from the multiplexer 90 that ramps down from the maximum voltage to the reset voltage.

Therefore, the “cap” waveform at the output of comparator 91 starts when the selected integrator begins integrating the sense voltage, VSNS, and ends when the selected integrator passes through the reset reference voltage. The sample and hold circuit 92 preserves the peak integrator voltage for the duration of the “cap” signal. The voltage references, VSLOPEMAX and VSLOPEMIN are derived by the MDACs 79 and 80 from the sample and hold output and the output of the control circuit 76. When the integrator voltage is between the two reference voltages, the “slope” signal is high. Since each integrator is only integrating the sense voltage, VSNS, on alternate cycles (the ones when it is not integrating the DAC output), two integrators are used, interleaved in time.

The dual slope technique, although requiring two integrator circuits, has significant advantages. First, simple continuous time RC integrators can be used. Second, there is no need for precisely known integrator gain or integration time. The transfer function between the DAC output and the average value of the sense voltage, VSNS, is governed primarily by the ratio of integration times.

Another embodiment would be to use the dual slope integrator and adjust the output value of the DAC 77 inversely with the power supply voltage. Thus if the supply voltage increases 10%, the DAC output will decrease 10%. In this way, the input power will be held constant, even as the power supply varies. In yet another embodiment, the first and last “slope” pulses in each commutation state may be digitally forced to 0% and 100% of the “cap” signal.

Thus, this method and circuit of the invention achieve similar performance to prior techniques, but do not require that the motor bemf be sinusoidal for optimum performance. Along with improved tolerance to bemf shape, this method is more tolerant of distortions such as finite slew rate in the output buffers, unequal motor phases, and misadjusted commutation advance. Whereas performance of the circuits and methods of the prior art are hindered by the small voltage difference between the motor bemf and the driving sinusoid, the methods and circuits of the present invention rely upon it.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A method for driving a polyphase dc motor, comprising:
pulse width modulating drive voltages to the motor during successive phase commutation cycles in respective pulse width modulated (PWM) cycles; and
transferring an equal amount of energy from a power supply to the motor in each PWM cycle.

2. The method of claim 1 wherein said transferring comprises:
measuring a quantity of energy transferred to said motor from a start of a PWM cycle,
and terminating said transferring when said quantity reaches a predetermined value.

3. The method of claim 2 wherein said measuring comprises:
accumulating a quantity in an integrator proportional to charge delivered to said motor during each PWM cycle;
and comparing said accumulated quantity with a predetermined value; and
providing an output signal when said accumulated value reaches said predetermined value.

4. A method for driving a polyphase do motor, comprising:
commutating drive voltages among respective windings of said motor;
pulse width modulating said drive voltages during each winding commutation by:
during a first commutation state:
applying pulses of a fixed width to a first winding;
applying pulses of successively increasing width to a second winding; and
conducting currents produced in said first and second windings through a third winding and a sense resistor connected thereto;
during a subsequent second commutation state:
applying pulses of said fixed width to said second winding;
applying pulses of successively decreasing width to said first winding; and
conducting currents produced in said first and second windings through said third winding and said sense resistor;
measuring an amount of energy delivered to said sense resistor during each pulse width modulating cycle;
and terminating said pulses during a pulse width modulating cycle if a predetermined fixed amount of energy is measured.

5. The method of claim 4 wherein said pulses of successively increasing width and said pulses of successively decreasing width are each centered about a center of a respective one of said pulses of fixed width.

6. The method of claim 4 wherein said measuring an amount of energy delivered to said sense resistor comprises integrating a voltage developed across said sense resistor from a start of a pulse width modulating cycle.

7. A circuit for driving a polyphase dc motor having first, second, and third windings, comprising:
means for commutating drive voltages among respective ones of said windings;
means for pulse width modulating said drive voltages during each commutation state, comprising:
means for applying pulses of fixed width to said first winding during a first commutation state;
means for applying pulses of successively increasing width to said second winding during said first commutation state;
means for conducting currents produced in said first and second windings through said third winding and a sense resistor connected thereto during said first commutation state;
means for applying pulses of said fixed width to said second winding during a subsequent second commutation state;
means for applying pulses of successively decreasing width to said first winding during said subsequent second commutation state;
means for conducting currents produced in said first and second windings through said third winding and said sense resistor during said subsequent second commutation state;
means for measuring an amount of energy delivered to said sense resistor during each pulse width modulating cycle;
and means for terminating said pulses during a pulse width modulating cycle if a predetermined fixed amount of energy is measured.

8. The circuit of claim 7 further comprising means for centering said pulses of successively increasing width and said pulses of decreasing width about a respective center of said pulses of fixed width.

9. The circuit of claim 7 wherein said means for measuring comprises means for integrating a voltage developed across said sense resistor from a start of a pulse width modulating cycle.

10. A circuit for driving a do motor having a plurality of windings, comprising:
a commutator for commutating drive voltages among said windings, wherein in each commutation cycle, drive voltages are applied to two of said windings and a current summed from currents induced by said drive voltages is sunk from a third of said windings;
a circuit for pulse width modulating said drive voltages during successive phase commutation cycles in respective pulse width modulated (PWM) cycles;
a circuit for measuring an amount of energy delivered to said motor from a beginning of each PWM cycle;
a circuit for terminating said drive voltages in a PWM cycle when said circuit for measuring measures a predetermined amount of energy which has been delivered to said motor during said PWM cycle.

11. The circuit of claim 10 wherein:
said circuit for pulse width modulating said drive voltages comprises:
a first threshold circuit for establishing a first threshold for comparison with an output of said circuit for measuring an amount of energy delivered to said motor,
said first threshold circuit having a first output for commutative delivery to one of said windings;
a second threshold circuit for establishing a second threshold for comparison with an output of said circuit for measuring an amount of energy delivered to said motor,
said second threshold circuit having a second output;
a third threshold circuit for establishing a third threshold for comparison with an output of said circuit for measuring an amount of energy delivered to said motor,
said third threshold circuit having a third output;
and a circuit for comparing said second and third outputs to provide a signal for commutative delivery to another of said windings when said output of said circuit for measuring an amount of energy delivered to said motor is between said second and third thresholds;
and a circuit for modifying said first, second, and third thresholds depending upon a number of pulse width modulated pulses delivered.

12. The circuit of claim 10 wherein said circuit for measuring an amount of energy delivered to said motor comprises an integrator that is reset at a beginning of each PWM cycle.

13. The circuit of claim 12 further comprising a sense resistor connected to receive said sunk current, and across which a voltage is developed by said sunk current that is connected to said integrator.

14. The circuit of claim 10 wherein said circuit for measuring an amount of energy delivered to said motor comprises a pair of integrators operable to respectively integrate alternate PWM cycles.

15. The circuit of claim 14 further comprising a sense resistor connected to receive said sunk current, and across which a voltage is developed by said sunk current that is alternatively connected to said integrators.

16. The circuit of claim 10 wherein a first of said drive voltages is pulse width modulated with a fixed duty cycle, and a second of said drive voltages is pulse width modulated with a linearly varying duty cycle.

17. The circuit of claim 16 wherein said second of said drive voltages is alternatingly pulse width modulated with increasing and decreasing duty cycles.

18. A mass data storage device, comprising:
a magnetic media;
a dc motor for rotating said magnetic media;
said dc motor having a plurality of windings to receive commutated drive voltages for spinning the motor;
a commutator for commutating drive voltages among said windings, wherein in each commutation cycle, drive voltages are applied to two windings and a current summed from currents induced by said drive voltages is sunk from a third winding;
a circuit for pulse width modulating said drive voltages during successive phase commutation cycles in respective pulse width modulated (PWM) cycles;
a circuit for measuring an amount of energy delivered to said motor from a beginning of each PWT4 cycle;
a circuit for terminating said drive voltages in a PWM cycle when said circuit for measuring measures a predetermined amount of energy which has been delivered to said motor during said PWM cycle.

19. The mass data storage device of claim 18 wherein said circuit for measuring an amount of energy delivered to said motor comprises an integrator that is reset at a beginning of each PWM cycle.

20. The mass data storage device of claim 19 further comprising a sense resistor connected to receive said sunk current, and across which a voltage is developed by said sunk current that is connected to said integrator.

21. The mass data storage device of claim 18 wherein said circuit for measuring an amount of energy delivered to said motor comprises a pair of integrators operable to respectively integrate alternate PWM cycles.

22. The mass data storage device of claim 18 further comprising a sense resistor connected to receive said sunk current, and across which a voltage is developed by said sunk current that is alternatively connected to said integrators.

23. The mass data storage device of claim 18 wherein a first of said drive voltages is pulse width modulated with a fixed duty cycle, and a second of said drive voltages is pulse width modulated with a linearly varying duty cycle.

24. The mass data storage device of claim 23 wherein said second of said drive voltages is alternatingly pulse width modulated with increasing and decreasing duty cycles.

25. The mass data storage device of claim 18 wherein said dc motor is a three-phase motor.

26. A method for operating a mass data storage device, comprising:
commutating drive voltages among windings of a dc motor of said mass data storage device for rotating a memory element thereof, wherein in each commutation cycle, drive voltages are applied to two windings and a current summed from currents induced by said drive voltages is sunk from a third winding;
pulse width modulating said drive voltages during successive phase commutation cycles in respective pulse width modulated (PWM) cycles;
measuring an amount of energy delivered to said motor from a beginning of each PWM cycle;
and terminating said drive voltages in a PWM cycle when said circuit for measuring measures a predetermined amount of energy which has been delivered to said motor during said PWM cycle.

27. The method of claim 26 wherein said measuring comprises providing an integrator that is reset at a beginning of each PWM cycle.

28. The method of claim 27 further comprising connecting a sense resistor to receive said sunk current, and across which a voltage is developed by said sunk current that is connected to said integrator.

29. The method of claim 27 wherein said measuring comprises providing a pair of integrators operable to respectively integrate alternate PWM cycles.

30. The method of claim 29 further comprising connecting a sense resistor to receive said sunk current, and across which a voltage is developed by said sunk current that is alternatively connected to said integrators.

31. The method of claim 26 wherein said pulse width modulating comprises pulse width modulating a first of said drive voltages with a fixed duty cycle, and pulse width modulating a second of said drive voltages with a linearly varying duty cycle.

32. The method of claim 31 wherein pulse width modulating said second of said drive voltages comprises alternatingly pulse width modulating said second of said drive voltages with increasing and decreasing duty cycles.

33. A method for pulse width modulating three drive voltages for application to a three phase load, comprising:
commutating said drive voltages among the phases of said load;
wherein in each pulse width modulation cycle, two of said drive voltages are applied to a respective two phases of said load, and a current summed from currents induced by said two of said drive voltages is sunk from a third phase of said load;
measuring an amount of energy delivered to said load from a beginning of each PWM cycle;
and terminating said drive voltages in a PWM cycle when a predetermined amount of energy which has been delivered to said motor during said PWM cycle has been measured.

34. The method of claim 33 further comprising:
modulating one of said two drive voltages to produce a series of drive voltage pulses that are of constant width;
and modulating another of said two drive voltages to produce a series of drive voltages pulses that are of linearly varying widths.

35. The method of claim 34 wherein said modulating another of said two drive voltages to produce a series of drive voltages pulses that are of linearly varying widths comprises alternatingly modulating said another of said two drive voltages to produce a series of drive voltage pulses that are of successively linearly increasing width and successively linearly decreasing width in successive pulse width modulation cycles.

36. The method of claim 35 further comprising centering said increasing and decreasing width pulses about respective pulses of fixed width.
